(19) United States
(12) Patent Application Publication
(10) Pub. No.: US 2023/0306083 A1
(43) Pub. Date: Sep. 28, 2023

(54) PLATFORM-AWARE TRANSFORMER-BASED PERFORMANCE PREDICTION

(71) Applicant: MediaTek Inc., Hsinchu (TW)

(72) Inventor: Hao-Yun Chen, Hsinchu (TW)

(21) Appl. No.: 17/701,745

(22) Filed: Mar. 23, 2022

(51) Int. Cl. G06K 9/62; G06N 3/08; G06N 3/04

(52) U.S. Cl. CPC G06K 9/6262; G06N 3/08; G06N 3/04

(57) ABSTRACT

A prediction engine predicts the performance of a neural network model executed on a hardware platform. The neural network model is compiled for the hardware platform. The neural network model includes multiple layers and each layer is defined by a set of operations and corresponding configuration settings of the operations. For each layer, the prediction engine performs feature embedding on the set of operations and the corresponding configuration settings to generate a feature embedded sequence of categorical feature vectors and numerical feature vectors. Positional encoding and a series of attention functions are applied on the feature embedded sequence to generate an encoded sequence. The prediction engine reduces the dimensions of the encoded sequence to output a performance metric of executing the neural network model on the hardware platform.

### TECHNICAL FIELD

Embodiments of the invention relate to a transformer-based neural network that predicts the performance of executing a neural network on a hardware platform.

### BACKGROUND

To optimize software performance, software developers sometimes tune their code for a specific hardware platform before the deployment of the software. An estimation or prediction of the software performance on the hardware platform can help the developers to identify potential problems in the code before the deployment. Conventionally, hardware engineers provide software developers with a lookup table that contains performance measurements of executing typical operations on the hardware platform. The software developers then use the lookup table to estimate the performance of the software when it is executed on the hardware platform.

However, constructing such a lookup table is time-consuming. Moreover, the lookup table is unable to capture correlations among operations and the effect of correlations on the performance. Furthermore, a hardware vendor may want to safeguard its propriety information regarding the hardware platform and may not want to provide such a lookup table to software developers.

Therefore, there is a need for improving the performance prediction of software executed on a hardware platform.

### SUMMARY

In one embodiment, a method is provided for predicting the performance of a neural network model executed on a hardware platform. The method comprises the step of receiving the neural network model compiled for the hardware platform. The neural network model includes a plurality of layers and each layer is defined by a set of operations and corresponding configuration settings of the operations. The method further comprises the steps of performing, for each layer, feature embedding on the set of operations and the corresponding configuration settings to generate a feature embedded sequence of categorical feature vectors and numerical feature vectors; and applying positional encoding and a series of attention functions on the feature embedded sequence to generate an encoded sequence. The method further comprises the step of reducing the dimensions of the encoded sequence to output a performance metric of executing the neural network model on the hardware platform.

In another embodiment, a system is operative to predict the performance of a neural network model executed on a hardware platform. The system comprises memory to store the neural network model compiled for the hardware platform. The neural network model includes a plurality of layers and each layer is defined by a set of operations and corresponding configuration settings of the operations. The system further comprises processing circuitry coupled to the memory and operative to perform, for each layer, feature embedding on the set of operations and the corresponding configuration settings to generate a feature embedded sequence of categorical feature vectors and numerical feature vectors; apply positional encoding and a series of attention functions on the feature embedded sequence to generate an encoded sequence; and reduce dimensions of the encoded sequence to output a performance metric of executing the neural network model on the hardware platform.

Other aspects and features will become apparent to those ordinarily skilled in the art upon review of the following description of specific embodiments in conjunction with the accompanying figures.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 is a diagram illustrating a transformer-based prediction engine according to one embodiment.

FIG. 2 is a block diagram illustrating a feature embedding module according to one embodiment.

FIG. 3 is a detailed diagram of the prediction engine according to one embodiment

FIG. 4 is a flow diagram illustrating a method for predicting the performance of a neural network model executed on a hardware platform according to one embodiment.

FIG. 5 is a diagram illustrating a system operative to perform performance prediction according to one embodiment.

### DETAILED DESCRIPTION

In the following description, numerous specific details are set forth. However, it is understood that embodiments of the invention may be practiced without these specific details. In other instances, well-known circuits, structures, and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

Transformers have had great success in natural language processing (NLP), such as machine translations. A description of a transformer design can be found in the paper authored by Vaswani et al. “Attention Is All You Need,” 31st Conference on Neural Information Processing Systems (NIPS 2017), Long Beach, CA, USA. The transformer (“conventional transformer”) described in that paper is a neural network architecture with an encoder-decoder structure to transform an input sequence (e.g., a sentence in a first language) into an output sequence (e.g., a translated sentence in a second language).

Embodiments of the invention provide a system and method for a transformer-based prediction engine (“prediction engine”) to predict the performance of a neural network model executed on a target hardware platform. The performance prediction is platform aware; i.e., the prediction reflects the capabilities and limitations of the underlying hardware. The performance prediction is ultra-fast and protects propriety hardware information. The prediction engine is a transformer-based neural network, which receives a compiled neural network as input, and outputs one or more performance metrics indicating the predicted performance. A hardware vendor may train the prediction engine for neural networks executed on its hardware platform (e.g., a deep learning accelerator) and provide the trained prediction engine to neural network developers. As such, the details of the hardware platform can be hidden from the developers.

A conventional transformer includes an encoder stack that sends its output to a decoding stack. The prediction engine disclosed herein includes an encoder stack that sends its output to a series of fully-connected layers to generate predicted performance. The encoder stack of the prediction engine encodes a vector sequence generated from positional encoding and feature embedding. The feature embedding produces a sequence of categorical feature vectors and numerical feature vectors from a compiled neural network.

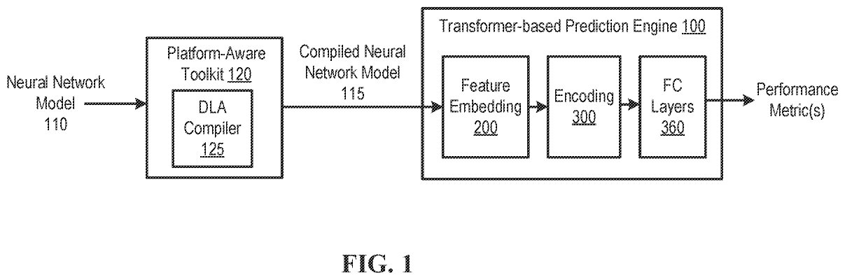

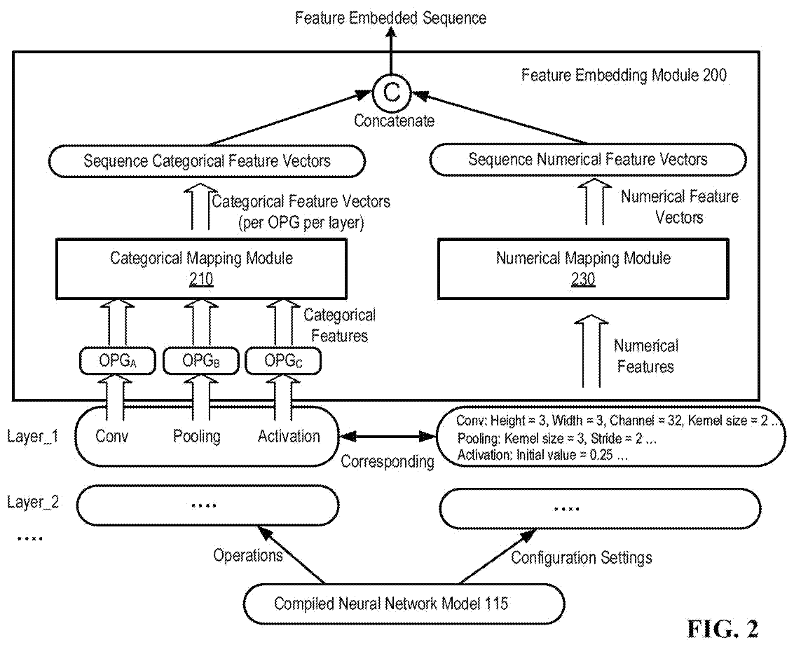

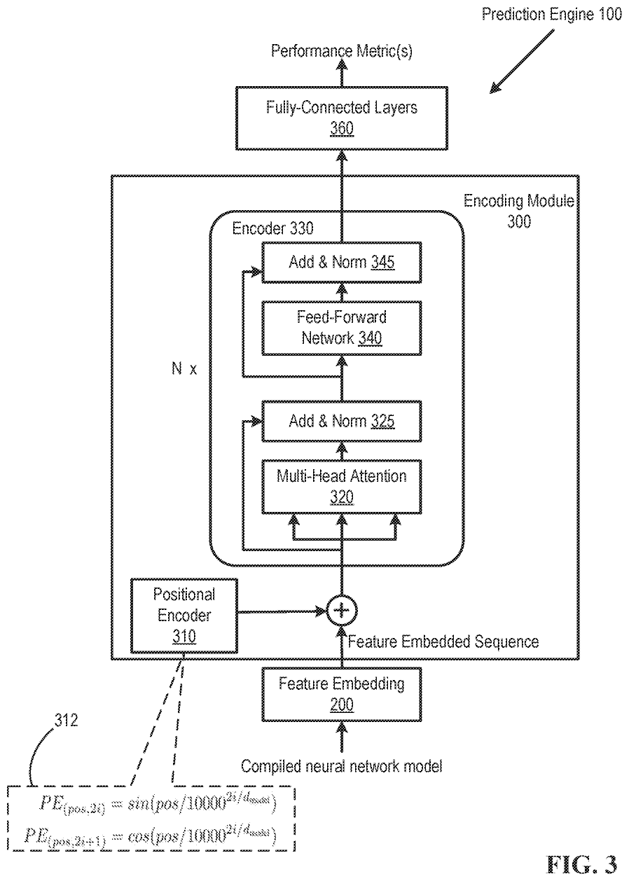

FIG. 1 is a diagram illustrating a transformer-based prediction engine 100 (“prediction engine 100”) according to one embodiment. A platform-aware toolkit 120 includes a deep learning accelerator (DLA) compiler 125 to compile a neural network model 110 into a compiled neural network model 115 for execution on a target hardware platform. The target hardware platform may be a deep learning accelerator or any hardware processing circuit that can execute the operations of a neural network model. The prediction engine 100 can predict the performance of the compiled neural network model 115 executed on the target hardware platform. In one embodiment, the neural network model 110 is a deep neural network (DNN). The compiled neural network model 115 indicates the operations and the corresponding configuration settings of each layer of the neural network model 110 in a data format compatible with the target hardware platform. The prediction engine 100 takes the compiled neural network model 115 as input, and outputs one or more performance metrics that may include, but are not limited to, latency, power consumption, number of execution cycles, etc. The prediction engine 100 includes a feature embedding module 200, which converts the compiled neural network model 115 to a long sequence of categorical feature vectors and numerical feature vectors. Further details of the feature embedding module 200 will be provided with reference to FIG. 2. The prediction engine 100 further includes an encoding module 300 and fully-connected layers 360, which will be described with reference to FIG. 3. In one embodiment, the prediction engine 100 is a transformer-based neural network, which can cope with a long sequence of vectors (e.g., a sequence of thousands of vectors) with self-attention. The feature embedding module 200 may pad the categorical feature vectors and numerical feature vectors to a predetermined length with a predetermined value (e.g., zero).

In one embodiment, the prediction engine 100 is trained with training data (e.g., training neural networks). The difference (e.g., mean-square error) between the prediction engine 100 output and a simulated output is calculated and is used to update the trainable parameters of the prediction engine 100. The simulated output may be generated by the actual target hardware platform. The operations of the prediction engine 100 may be executed by central processing units, graphics processing units, neural processing units, or other processing circuitry.

FIG. 2 is a block diagram illustrating the feature embedding module 200 according to one embodiment. The feature embedding module 200 can convert the compiled neural network model 115 to a sequence of categorical feature vectors and numerical feature vectors. The compiled neural network model 115 is described by operations and the corresponding configuration settings of each layer of the compiled neural network model 115. The operations are also referred to as categorical features and can be categorized into a set of operation groups (OPG). For example, “convolution” may be a categorical feature and mapped to an OPG. In some embodiments, different types of convolutions (e.g., depth-wise convolution, 1×1 convolution, etc.) may be mapped to different OPGs. The configuration setting of each OPG is referred to as a numerical feature. For example, a numerical feature of a convolution OPG may include: height, width, channel, kernel size, . . . etc. Parameters such as weights and bias of a convolution operation are not included as part of a numerical feature.

The feature embedding module 200 includes a categorical mapping module 210, which maps each categorical feature to a token value, and from the token value to a categorical feature vector. The mapping from the token value to the value of the categorical feature vector is learned during training of the prediction engine 100. That is, the value of the categorical feature vector can be learned from training. The number of elements in a categorical feature vector, also called embedding size or model size, is predetermined. In one embodiment, each element of a categorical feature vector is a floating-point number. In one embodiment, different elements of a categorical feature vector may indicate different attributes that can be related to different ones of other vectors.

The feature embedding module 200 further includes a numerical mapping module 230. Each OPG has a corresponding configuration setting, which is also referred to as the numerical feature of the OPG. The numerical mapping module 230 maps each numerical feature to a numerical feature vector. The mapping from the numerical feature to the numerical feature vector value is learned during training of the prediction engine 100. That is, the value of the numerical feature vector can be learned from training. In one embodiment, each element of a numerical feature vector is a floating number that indicates a configuration setting (e.g., height, width, or kernel size) of the corresponding categorical feature. The number of elements in a numerical feature vector is the same predetermined number as the number of elements in a categorical feature vector. A categorical feature vector, as well as a numerical feature vector, may be padded to reach the predetermined embedding size.

In the example of FIG. 2, the first layer of the compiled neural network model 115 may include convolution, pooling, and an activation function, which are mapped to OPG_A, OPG_B, OPG_C, respectively. The categorical mapping module 210 maps each OPG in each layer to a categorical feature vector. The categorical feature vectors of all layers of the compiled neural network model 115 form a sequence of categorical feature vectors, which may be padded to reach a predetermined sequence length.

The numerical feature of each OPG is mapped to a numerical feature vector. In the example of FIG. 2, the convolution operation (OPG_A) in layer one has a corresponding numerical feature of height=3, width=3, channel=32, kernel size=2, etc. The pooling operation (OPG_B) in layer one has a corresponding numerical feature of kernel size=3, stride=2, etc. The activation function (OPG_C) in layer one has a corresponding numerical feature of initial value=0.25, etc. The numerical mapping module 230 maps the numerical feature to a numerical feature vector. Then all of the numerical feature vectors of all layers of the compiled neural network model 115 form a sequence of numerical feature vectors, which may be padded to reach a predetermined sequence length. The sequence length of categorical feature vectors may be equal to the sequence length of numerical feature vectors. The two sequences (categorical feature vectors sequence and numerical feature vectors sequence) are concatenated to produce a feature embedded sequence. After the feature embedding, positional encoding and a series of attention functions are performed on the feature embedded sequence to generate an encoded sequence.

FIG. 3 is a detailed diagram of prediction engine 100 according to one embodiment. The prediction engine 100 includes the feature embedding module 200 described in FIG. 2 and the encoding module 300. The encoding module 300 includes a positional encoder 310 and a series of encoders 330. Each vector in the feature embedded sequence is encoded by the positional encoder 310. In one embodiment, the positional encoder 310 calculates sine and cosine functions of each element of each vector as shown in block 312, where pos is the vector's position in the feature embedded sequence, i is the dimension index of the element (i.e., the i-th element in the vector), and d_model is the model size (i.e., the embedding size, which is the number of elements in the vector). The output of the positional encoder 310 is added to the feature embedded sequence generated from the feature embedding module 200, and the sum is sent to a series of encoders 330 as encoder input. Positional encoding captures order dependencies among elements of the encoder input, and distinguishes among the same operation that is present multiple times in the feature embedding.

In one embodiment, the series of encoders 330 includes N encoders 330 connected in series. Each encoder 330 includes two sub-layers. The first sub-layer includes a multi-head attention module 320 to perform an attention function, such as the multi-head attention function, and an add-and-norm module 325 to perform addition and normalization operations. The second sub-layer includes a feed-forward network 340 followed by an add-and-norm module 345.

The multi-head attention module 320 is the kernel of the prediction engine 100. An attention function can be described as mapping a query and a set of key-value pairs to an output, where the query, keys, values, and output are all vectors. The output is computed as a weighted sum of the values. An example of an attention function may be a scaled dot product attention function. The multi-head attention module 320 performs multiple attention functions in parallel. A detailed description of multi-head attention is provided in the aforementioned paper by Vaswani et al. “Attention Is All You Need.”

The add-and-norm module 325 adds the input and the output of the multi-head attention module 320 to generate a sequence of sums, and performs layer-wise normalization on the sequence of sums; e.g., normalizing the sequence of sums such that the mean and the standard deviation across the dimensions are 0 and 1, respectively. The output of the first sublayer is fed into the second sublayer.

In one embodiment, the feed-forward network 340 is a fully-connected feed-forward network, which is applied to each position separately, to perform linear transformations and activation such as the ReLU activation. The operations of the first sublayer and the second sublayer are repeated N times. The output of the last encoder 330 in the series is sent to a series of fully-connected (FC) layers 360.

The fully-connected layers 360 perform matrix multiplication, activation, and batch normalization on the output of the encoding module 300. The fully-connected layers 360 reduce the dimensions of the encoder output one layer after another. Using the notation of FC_j [input layer dimensions, output layer dimensions], where j is the FC layer index, the dimensions may be reduced as follows: FC_1 [512, 256], FC_2 [256, 128], FC_3 [128, 1]. The final output is a numerical value (e.g., a floating-point number), which is the predicted performance metric.

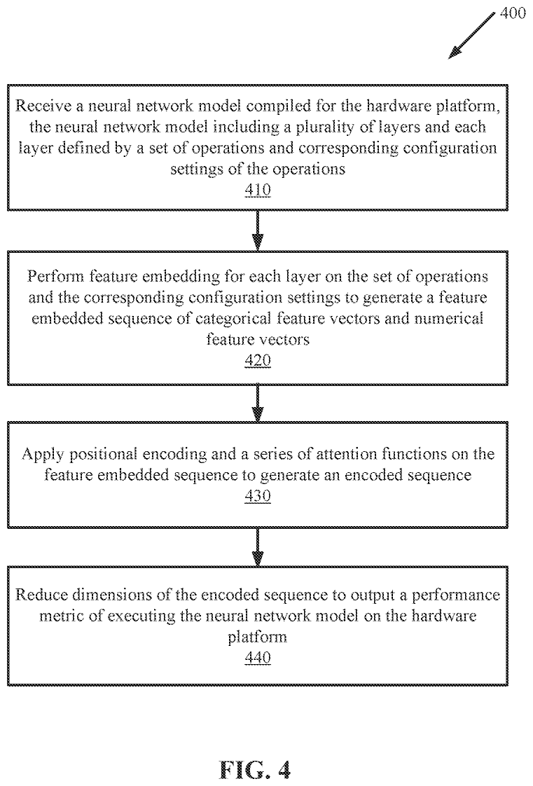

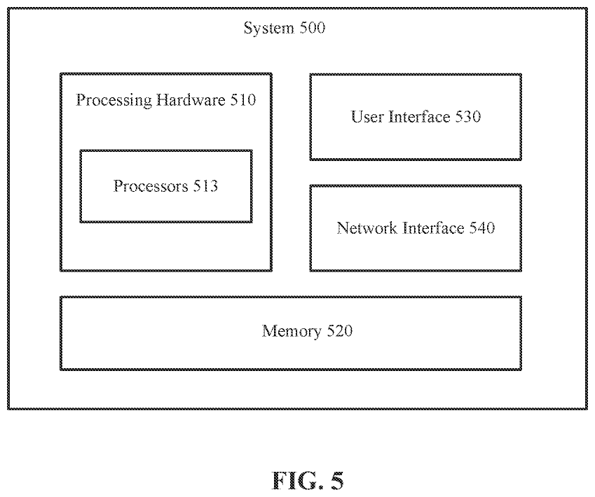

The prediction engine 100 described in FIGS. 1-3 may be implemented on a system; e.g., a system 500 in FIG. 5, to perform a method 400 in FIG. 4. FIG. 4 is a flow diagram illustrating a method 400 for predicting the performance of a neural network model executed on a hardware platform according to one embodiment. The method 400 begins at step 410 when the system receives a neural network model compiled for the hardware platform. The neural network model includes multiple layers and each layer is defined by a set of operations and corresponding configuration settings of the operations. The system at step 420 performs, for each layer, feature embedding on the set of operations and the corresponding configuration settings to generate a feature embedded sequence of categorical feature vectors and numerical feature vectors. At step 430, the system applies positional encoding and a series of attention functions on the feature embedded sequence to generate an encoded sequence. At step 440, the system reduces the dimensions of the encoded sequence to output a performance metric of executing the neural network model on the hardware platform. In one embodiment, the dimensions of the encoded sequence may be reduced by using a series of fully-connected layers. In one embodiment, the performance metric may include one or more of: latency, execution cycles, and power consumption.

In one embodiment, a first sequence of the categorical feature vectors for all layers of the neural network model and a second sequence of the numerical feature vectors are concatenated to generate the feature embedded sequence. Each categorical feature vector corresponds to an operation group in the set of operations. The operation group may include one of: convolution, pooling, and an activation function. The feature embedding may be trained to map each operation to a categorical feature vector that has a trainable vector value and a predetermined embedding size. In one embodiment, one or more of the numerical feature vectors indicate height, width, and the number of channels in a corresponding convolution operation.

In one embodiment, the series of attention functions include a series of multi-head attention functions that identify correlations among vectors in the sequence. The input and output of each attention function are added to generate a sequence of sums, which are normalized to generate an output to a feed-forward network.

FIG. 5 is a diagram illustrating a system 500 according to one embodiment. The system 500 includes hardware circuits for executing the operations described in connection with FIGS. 1-4. The system 500 includes processing hardware 510. In one embodiment, the processing hardware 510 may include one or more processors 513, such as central processing units (CPUs), graphics processing units (GPUs), digital processing units (DSPs), artificial intelligence (AI) processors, neural processing units, and other general-purpose and/or special-purpose processing circuitry. Referring back to FIGS. 1-4, the one or more processors 513 may execute instructions stored in a memory 520 to perform operations of the prediction engine 100.

The memory 520 is coupled to the processing hardware 510. The memory 520 may include dynamic random access memory (DRAM), SRAM, flash memory, and other non-transitory machine-readable storage media; e.g., volatile or non-volatile memory devices. The memory 520 may further include storage devices, for example, any type of solid-state or magnetic storage device. In one embodiment, the memory 520 may store instructions which, when executed by the processing hardware 510, cause the processing hardware 510 to perform the aforementioned performance prediction, such as the method 400 in FIG. 4.

The system 500 may also include a user interface 530 to acquire information from and/or display output to users. In some embodiments, the system 500 may also include a network interface 540 to connect to a wired and/or wireless network for transmitting and/or receiving voice, digital data, and/or media signals. It is understood the embodiment of FIG. 5 is simplified for illustration purposes. Additional hardware components may be included.

The operations of the flow diagram of FIG. 4 have been described with reference to the exemplary embodiments of FIGS. 1-3 and 5. However, it should be understood that the operations of the flow diagram of FIG. 4 can be performed by embodiments of the invention other than the embodiments of FIGS. 1-3 and 5, and the embodiments of FIGS. 1-3 and 5 can perform operations different than those discussed with reference to the flow diagram. While the flow diagram of FIG. 4 shows a particular order of operations performed by certain embodiments of the invention, it should be understood that such order is exemplary (e.g., alternative embodiments may perform the operations in a different order, combine certain operations, overlap certain operations, etc.).

Various functional components or blocks have been described herein. As will be appreciated by persons skilled in the art, the functional blocks will preferably be implemented through circuits (either dedicated circuits or general-purpose circuits, which operate under the control of one or more processors and coded instructions), which will typically comprise transistors that are configured in such a way as to control the operation of the circuitry in accordance with the functions and operations described herein.

While the invention has been described in terms of several embodiments, those skilled in the art will recognize that the invention is not limited to the embodiments described, and can be practiced with modification and alteration within the spirit and scope of the appended claims. The description is thus to be regarded as illustrative instead of limiting.

What is claimed is:

1. A method for predicting performance of a neural network model executed on a hardware platform, comprising:
receiving the neural network model compiled for the hardware platform, the neural network model including a plurality of layers and each layer defined by a set of operations and corresponding configuration settings of the operations;
performing, for each layer, feature embedding on the set of operations and the corresponding configuration settings to generate a feature embedded sequence of categorical feature vectors and numerical feature vectors;
applying positional encoding and a series of attention functions on the feature embedded sequence to generate an encoded sequence; and
reducing dimensions of the encoded sequence to output a performance metric of executing the neural network model on the hardware platform.

2. The method of claim 1, wherein performing feature embedding further comprises:
concatenating a first sequence of the categorical feature vectors for all layers of the neural network model and a second sequence of the numerical feature vectors to generate the feature embedded sequence.

3. The method of claim 1, wherein each categorical feature vector corresponds to an operation group in the set of operations.

4. The method of claim 3, wherein the operation group includes one of: convolution, pooling, and an activation function.

5. The method of claim 1, further comprising:
training the feature embedding to map each operation to a categorical feature vector that has a trainable vector value and a predetermined embedding size.

6. The method of claim 1, wherein one or more of the numerical feature vectors indicate height, width, and number of channels in a corresponding convolution operation.

7. The method of claim 1, wherein the performance metric includes one or more of: latency, execution cycles, and power consumption.

8. The method of claim 1, wherein reducing the dimensions of the encoded sequence further comprises:
reducing the dimensions of the encoded sequence using a series of fully-connected layers.

9. The method of claim 1, wherein the series of attention functions include a series of multi-head attention functions that identify correlations among vectors in the sequence.

10. The method of claim 1, further comprising:
adding input and output of each attention function to generate a sequence of sums; and
normalizing the sequence of sums to output to a feed-forward network.

11. A system operative to predict performance of a neural network model executed on a hardware platform, comprising:
memory to store the neural network model compiled for the hardware platform, the neural network model including a plurality of layers and each layer defined by a set of operations and corresponding configuration settings of the operations; and
processing circuitry coupled to the memory and operative to:
perform, for each layer, feature embedding on the set of operations and the corresponding configuration settings to generate a feature embedded sequence of categorical feature vectors and numerical feature vectors;
apply positional encoding and a series of attention functions on the feature embedded sequence to generate an encoded sequence; and
reduce dimensions of the encoded sequence to output a performance metric of executing the neural network model on the hardware platform.

12. The system of claim 11, wherein the processing circuitry is further operative to:
concatenate a first sequence of the categorical feature vectors for all layers of the neural network model and a second sequence of the numerical feature vectors to generate the feature embedded sequence.

13. The system of claim 11, wherein each categorical feature vector corresponds to an operation group in the set of operations.

14. The system of claim 11, wherein the operation group includes one of: convolution, pooling, and an activation function.

15. The system of claim 11, wherein the processing circuitry is further operative to:
train the feature embedding to map each operation to a categorical feature vector that has a trainable vector value and a predetermined embedding size.

16. The system of claim 11, wherein one or more of the numerical feature vectors indicate height, width, and number of channels in a corresponding convolution operation.

17. The system of claim 11, wherein the performance metric includes one or more of: latency, execution cycles, and power consumption.

18. The system of claim 11, wherein the processing circuitry is further operative to:
reduce the dimensions of the encoded sequence using a series of fully-connected layers.

19. The system of claim 11, wherein the series of attention functions include a series of multi-head attention functions that identify correlations among vectors in the sequence.

20. The system of claim 11, wherein the processing circuitry is further operative to:
add input and output of each attention function to generate a sequence of sums; and
normalizing the sequence of sums to output to a feed-forward network.
